(19) United States
(12) Patent Application Publication
(10) Pub. No.: US 2010/0119421 A1
(43) Pub. Date: May 13, 2010

(54) Catalyst support, method of manufacturing the same, and reformer having the same

(76) Inventors: Jin-Goo Ahn, Suwon-si (KR); Sung-Chul Lee, Suwon-si (KR); In-Hyuk Son, Suwon-si (KR); Woo-Cheol Shin, Suwon-si (KR); In--Seob Song, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/588,538

(22) Filed: Oct. 19, 2009

(30) Foreign Application Priority Data
Nov. 11, 2008 (KR) 10-2008-0111508

(51) Int. Cl. B01J 35/04; B01J 32/00; C01B 3/38; B01J 7/00

(52) U.S. Cl. 422/188; 502/439; 422/222

(57) ABSTRACT

A catalyst support includes a base member, and a plurality of paths extending through the base member in a first direction from a first end of the base member to a second end of the base member. Each path has a first end at the first end of the base member and a second end at the second end of the base member, and the first ends of the paths are disposed at different intervals from a plane that is perpendicular to the first direction.

### BACKGROUND

1. Field

Embodiments relate to a catalyst support, a method of manufacturing the same, and a reformer having the same.

2. Description of the Related Art

A fuel cell may be implemented in a power generation system that produces power using hydrogen gas. The fuel cell may be efficient, may not produce pollutants such as nitrogen oxides, sulfur oxides, particulates, etc., and, as such, may be environmentally friendly. Hydrogen gas may be generated through a decomposition reaction, a reforming reaction, etc. Hydrogen gas may be generated from a fuel such as hydrocarbon, e.g., methane gas, propane gas, gasoline, an alcohol such as methanol or ethanol, an ether such as dimethyl ether, etc. A reformer may be used as an apparatus to generate high purity hydrogen gas from a hydrocarbon. The reformer may operate using, e.g., steam reforming, partial oxidation reforming, autothermal reforming, etc. Reforming reactions may be facilitated by a catalyst. The catalyst may be impregnated in, or coated on, a support. Both the catalyst and the support may have maximum temperatures beyond which chemical and/or physical degradation may occur.

### SUMMARY

Embodiments are directed to a catalyst support, a method of manufacturing the same, and a reformer having the same, which substantially overcome one or more of the problems due to the limitations and disadvantages of the related art.

It is therefore a feature of an embodiment to provide a catalyst support configured to reduce hot spots, a method of manufacturing the same, and a reformer having the same.

It is therefore another feature of an embodiment to provide a catalyst support having a long life time, a method of manufacturing the same, and a reformer having the same.

At least one of the above and other features and advantages may be realized by providing a catalyst support, including a base member, and a plurality of paths extending through the base member in a first direction from a first end of the base member to a second end of the base member. Each path has a first end at the first end of the base member and a second end at the second end of the base member, and the first ends of the paths may be disposed at different intervals from a plane that is perpendicular to the first direction.

The first end of the base member may be an inlet and the second end of the base member may be an outlet.

A first set of paths may have first ends disposed at a first interval from the plane, a second set of paths may have first ends disposed at a second interval from the plane, and the second interval may be different from the first interval, such that the first ends of the second set of paths are offset from the first ends of the first set of paths.

The base member may have an outer periphery and a center, and the second set of paths may be disposed closer to the outer periphery than the first set of paths.

The catalyst support may be symmetric when rotated about a central axis, the central axis being parallel to the first direction.

The catalyst support may be asymmetric when rotated about a central axis, the central axis being parallel to the first direction.

The first ends of the paths may be tilted from a peripheral edge of the base member to an opposite peripheral edge of the base member based on a cross-section of the base member that is parallel to the plane.

The first end portions of the paths may be arranged to form a ripple shape that extends in a direction parallel with an extending direction of the plane.

A maximum value of the intervals from the plane may increase in correspondence with a cell density of the paths.

The base member may include a first base member having a sheet shape and a second base member having a ripple shape and being in contact with one surface of the first base member, the first base member and the second base member may overlap and may be wound in a spiral structure, and the paths may be formed between the first base member and the second base member, sidewalls of the paths being at least partially defined by the ripple shape of the second base member.

A path at a central portion of the spiral structure formed by the first base member and second base member may have the largest interval from the plane.

The first end portions of the paths may be arranged in a spiral tower shape, and the first ends of the paths may be arranged in a plurality of steps from a peripheral edge of the spiral structure to the central portion of the spiral structure based on a cross-section of the spiral structure that is parallel to the first direction.

At least one of the first base member and the second base member may be formed of a thermally conductive material or a metallic material.

The base member may be formed of a ceramic material having a plurality of penetration holes, the plurality of paths being defined by the plurality of penetration holes.

The catalyst support may further include catalyst materials disposed in each of the paths.

At least one of the above and other features and advantages may also be realized by providing a method of manufacturing a catalyst support, the method including providing a first base member having a sheet shape, providing a second base member having a ripple shape, forming a spiral structure by overlapping and spirally winding the first base member and the second base member, and offsetting a central portion of the spiral structure by a predetermined interval in a direction parallel to a winding axis of the spiral structure so that a central portion of the spiral structure projects relative to a peripheral edge portion of the spiral structure or is recessed relative to the peripheral edge portion of the spiral structure.

The method may further include fixing the first base member to the second base member.

At least one of the first base member and the second base member may be formed of a thermally conductive material or a metallic material.

The method may further include coating a catalyst material on a plurality of paths formed between the first base member and the second base member, where sidewalls of the paths are at least partially defined by the ripple shape of the second base member.

At least one of the above and other features and advantages may also be realized by providing a reformer, including a first chamber for a target reaction, and a first catalyst support disposed in the first chamber. The first catalyst support may include a base member, and a plurality of paths extending through the base member in a first direction from a first end of the base member to a second end of the base member. Each path has a first end at the first end of the base member and a second end at the second end of the base member, and the first ends of the paths may be disposed at different intervals from a plane that is perpendicular to the first direction.

The target reaction may include at least one of a catalyst-promoted reforming reaction and a catalyst-promoted oxidation reaction.

The reformer may further include a second chamber surrounding the first chamber, and a second catalyst support disposed in the second chamber.

The first chamber may have a first spiral structure, and the second chamber may have a second spiral structure, the second spiral structure encircling the first spiral structure.

### BRIEF DESCRIPTION OF THE DRAWINGS

The above and other features and advantages will become more apparent to those of ordinary skill in the art by describing in detail example embodiments with reference to the attached drawings, in which:

FIG. 1 illustrates a catalyst support according to a first embodiment;

FIG. 2A illustrates a cross-sectional view of the catalyst support of FIG. 1 taken along line I-I of FIG. 1;

FIG. 2B illustrates a cross-sectional view of the catalyst support of FIG. 1 taken along line II-II of FIG. 1;

FIGS. 3A and 3B illustrate perspective views explaining a method of manufacturing the catalyst support of FIG. 1;

FIGS. 4A and 4B illustrate perspective views explaining a method of manufacturing a catalyst support according to a second embodiment;

FIG. 5A-5C illustrate cross-sectional views of a reformer according to a third embodiment;

FIGS. 6A-6B illustrate cross-sectional views of a reformer according to a fourth embodiment.

### DETAILED DESCRIPTION

Korean Patent Application No. 10-2008-0111508, filed on Nov. 11, 2008, in the Korean Intellectual Property Office, and entitled: “Monolith Catalyst Support and Manufacturing Method Thereof and Reformer Having the Monolith Catalyst Support” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Herein, a catalyst support according to an embodiment may be a device that supports a catalyst. Catalyst materials may be coated on the support or impregnated in the support. In an implementation, the material forming the catalyst support may be made of or include the catalyst materials, etc. The catalyst support may be a base member having a plurality of paths on which catalyst materials can be coated. Also, the catalyst support may be a catalyst carrier where a metal-support forms a catalyst. For example, the catalyst support may include the catalyst directly impregnated by oxidizing and/or reducing the base member having a plurality of paths. The catalyst for which the catalyst support provides support may be a catalyst used to perform, e.g., a reforming reaction in a reforming reactor, an oxidation reaction in an oxidation reactor, etc.

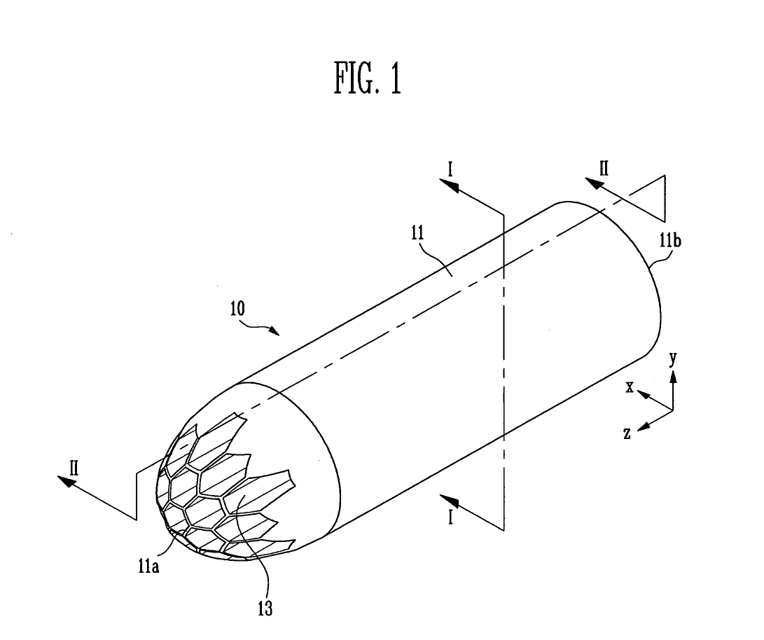

FIG. 1 illustrates a catalyst support according to a first embodiment.

Referring to FIG. 1, the catalyst support 10 may have a high specific surface area in order to facilitate contact between catalysts, e.g., solid catalysts, and reaction gas. The catalyst support 10 may optimize the function of the catalysts by increasing the surface areas of the catalysts.

The catalyst support 10 may include a base member 11 and a plurality of paths 13 penetrating the base member 11, i.e., extending through the base member 11 so as to allow a fluid, e.g., a gas, to flow therethrough. The paths 13 may extend in a first direction (Z direction). The base member 11 may have an outer shape that is, e.g., cylindrical. The base member 11 may have a predetermined length in the first direction and may include a first end surface 11a at an inlet-end thereof that exposes first end portions of the paths 13. The catalyst support 10 may include a second surface 11b at an outlet end thereof, the second surface 11b exposing second end portions of the paths 13. The catalyst support 10 may have the first end portions of the paths 13 positioned on the first surface 11a, the first end portions of the paths 13 being disposed to have different intervals from a virtual plane (X-Y plane) that is perpendicular to the first direction.

Each path 13 of the catalyst support 10 may be coated with catalysts, so that the catalyst support 10 may be used as a catalyst reactor for, e.g., an oxidation reaction or a reforming reaction, etc. A catalyst-promoted reaction may be most active at the first end (inlet side) of each path 13 because fluid (gas, liquid) may first encounter the catalyst at the first end as it enters the catalyst support 10 from the inlet end surface 11a.

According to an embodiment, hot spots, which may occur if heat from the catalyst-promoted reaction is highly localized, may be reduced or eliminated. In this regard, hot spots may occur in a reactor when an oxidation reaction or a reforming reaction is performed. Such hot spots may be generated when a catalyst-promoted reaction is concentrated in a specific region, and the temperature of the part where the hot spots are generated may be considerably higher than the temperature of other parts. If hot spots having an abnormally high temperature are generated, the hot spots may cause deactivation of the catalysts positioned on the region where the hot spots are generated, and regions adjacent thereto. In particular, if relatively large hot spots are formed in a specific region of the reactor at the time of the reaction, e.g., an oxidation reaction, a reforming reaction of methane, etc., a reaction temperature of about 800° C. or more may result. Such temperatures may cause the support where the catalyst is impregnated to deteriorate, and/or cause the catalyst to be deactivated. Thus, if large hot spots are generated, a metal catalyst may be degraded, the durability of the support may deteriorate, and the life span of the support and/or reactor may be significantly shortened. If a catalyst-promoted reaction is performed at a relatively high temperature, e.g., about 600° C. or more, on a support having a planar inlet, large hot spots may be formed in a specific region, e.g., an inlet part of a path into which fuel flows. The large hot spots generate various mechanical stresses, such that it may cause a catalyst deactivation and may deteriorate durability of the device.

The catalyst support according to the first embodiment may have a design in which inflow points of fluids that flow into each path 13 are different. Thus, the catalyst-promoted reaction in each path 13 may not be concentrated in a same region but may, instead, be dispersed. In an implementation, the first end portions of the plurality of paths 13 have different intervals from the X-Y plane, such that the catalyst-promoted reaction of fuel in the plurality of paths 13 is performed at dispersed locations. Therefore, the catalyst support according to the first embodiment may prevent the formation of large hot spots resulting from the relatively high temperature catalyst reaction, thereby reducing or preventing catalyst deactivation and deterioration of the durability of the device. Thus, the catalyst support 10 according to the first embodiment may maintain stable operation and performance of the device even in the relatively high temperature catalyst reaction.

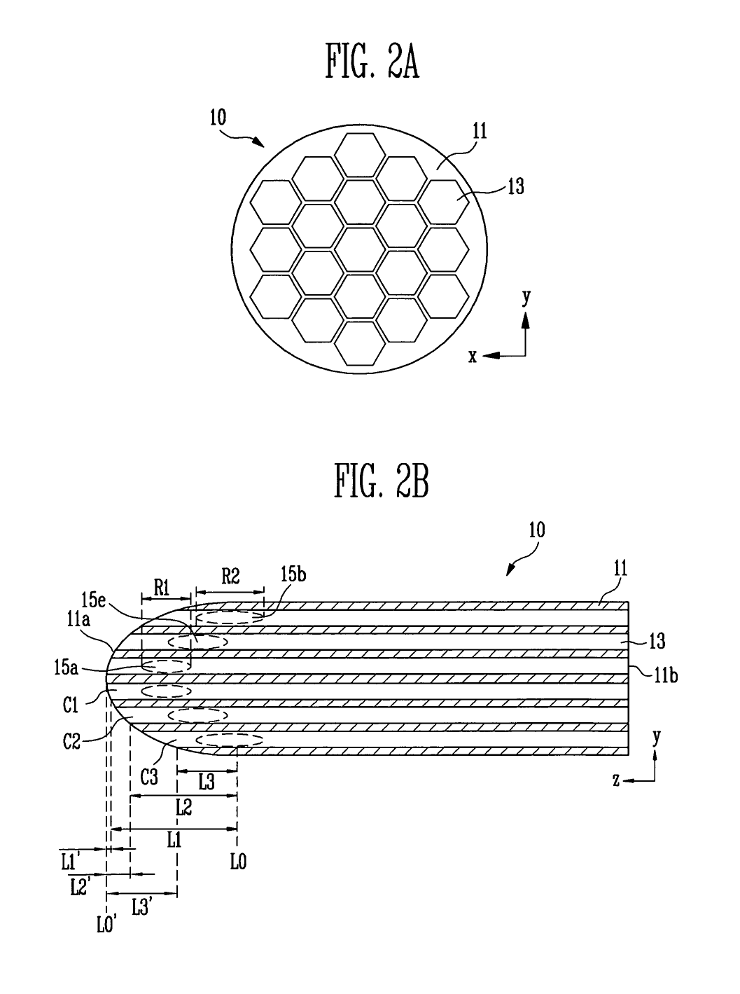

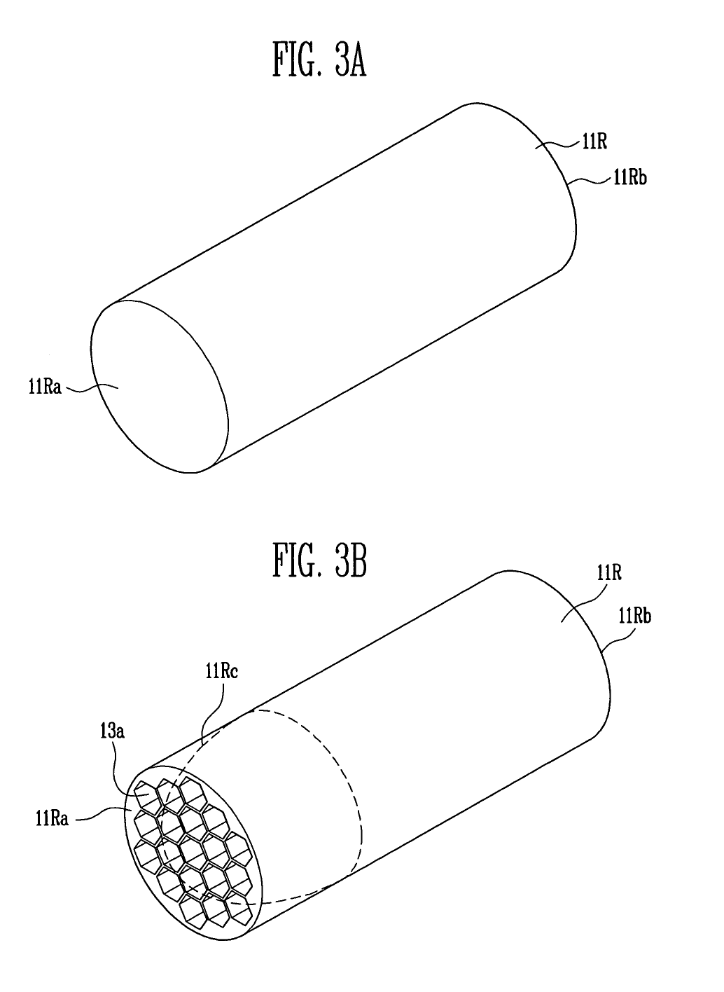

FIG. 2A illustrates a cross-sectional view of the catalyst support of FIG. 1 taken along line I-I of FIG. 1.

Referring to FIG. 2A, the catalyst support according to the first embodiment may include paths 13 that may have, e.g., a round cross-section in the X-Y plane, a square cross-section in the X-Y plane, a hexagonal cross-section in the X-Y plane, etc. The paths 13 may form a honeycomb pattern in a base member 11. The base member 11 may be, e.g., metal or ceramic. The base member 11 may be a monolithic structure, i.e., may be formed as a unitary structure, e.g., by casting, extruding, molding, etc. The base member 11 may have, e.g., a generally cylindrical shape with a circular cross-section, i.e., the outer periphery may form a circle. In other implementation, the base member 11 may have, e.g., various cross-sectional shapes such as a triangle, a rectangle, an oval, a polygon, etc.

The cell density of the paths 13 may be determined based on the particular application and may be configured to have a proper cell density. For example, the number of paths 13 and/or the cross-sectional area of each path 13 may be determined according to, e.g., a desired gas hourly space velocity (GHSV), a desired internal pressure, etc. The GHSV may represent a flow volume of reactants for a unit volume of the reactor, or a flow volume of reactants for a unit volume of the reactor catalyst. In each path 13, the cross-section (X-Y plane) of the upstream end into which fluid flows may be formed identically or differently from the downstream end from which the fluid is discharged, e.g., according to a desired condition such as GHSV, internal pressure, etc.

FIG. 2B illustrates a cross-sectional view of the catalyst support of FIG. 1 taken along line II-II of FIG. 1.

Referring to FIG. 2B, in the catalyst support 10 according to the first embodiment, the first end portions of the paths 13 may be disposed to have different intervals from a virtual X-Y plane that is perpendicular to the Z direction. For example, from an X-Y plane positioned on line L0 in FIG. 2B (hereinafter, L0 is referred to as a reference plane), the first end of a first path C1 may be positioned in the central portion of a first surface 11a of the base member 11 and is spaced apart in the Z direction from the reference plane L0 by a first length L1. The first end of a second path C2 may be spaced apart from the reference plane L0 by a second length L2 different from L1. A first end of a third path C3 positioned on the outer edge of the first surface 11a, i.e., an outermost path, may be spaced apart from the reference plane L0 by a third length L3 different from L1 and L2. The first length L1 may be larger than the second length L2, and the second length L2 may be larger than the third length L3. It will be appreciated that references herein to the reference plane L0 and lengths L1, L2, and L3 are merely for the sake of description. The intervals may also be described in terms of, e.g., a second reference plane L0′ located at the tip of the catalyst support 10. In such a case, the first end of the first path C1 may be spaced apart in the Z direction from the second reference plane L0′ by a first length L1′. The first end of the second path C2 may be spaced apart from the second reference plane L0′ by a second length L2′ different from L1′. The first end of the third path C3 positioned on the outer edge of the first surface 11a may be spaced apart from the second reference plane L0′ by a third length L3′ different from L1′ and L2′.

The catalyst support 10 may have a generally convex inlet end, i.e., the first surface 11a of the base member 11 may be convex. The first surface may be symmetrical with respect to the Z axis, i.e., may be symmetrical with respect to a central axis of the base member 11. Preferably, a region 15a where the catalyst reaction most actively occurs in the first path C1 is designed so that it does not completely overlap with an adjacent region 15c in the second path C2 where the catalyst reaction most actively occurs in the second path C2. In an implementation, an extent R1 of the region 15a in the first path C1 may not overlap an extent R2 of a region 15b in the third path C3, such that heat generated in the most active region of the first path C1 is displaced in the Z-direction relative to heat generated in the most active region of the third path C3. In an implementation, the region 15a may partially overlap the region 15c. The most active catalyst reaction regions in the respective paths 13 may thus be dispersed in the Z direction to reduce or eliminate hot spots. The catalyst support may be configured such that the regions 15a and 15b overlap somewhat in the Z direction, although the dispersion of the reaction heat may be reduced to a corresponding extent. Similarly, the interval between the regions 15a and 15b may be increased in the Z direction. In such a case, a projecting portion of the first end of the base member 11 may become thinner as the interval is increased, such that the mechanical strength may be reduced and/or processing time may be lengthened. It will be appreciated that overlap of regions 15a, 15b, and 15c, may be partial, or no overlap may exist, or a mixture of overlapping and non-overlapping regions may be provided.

Where the cross-sections of each of the plurality of paths 13 have the same area, as the cross-sections of the path 13 become smaller, the length in the Z direction of the region over which the catalyst reaction most actively occurs in the respective paths 13 may be lengthened. Thus, in an implementation, the catalyst support 10 may be designed to have a larger extent that the central portion is projected, i.e., the first surface 11a of the base member 11 may project more, as the average cross-section of the plurality of paths 13 is reduced, that is, as the cell density increases.

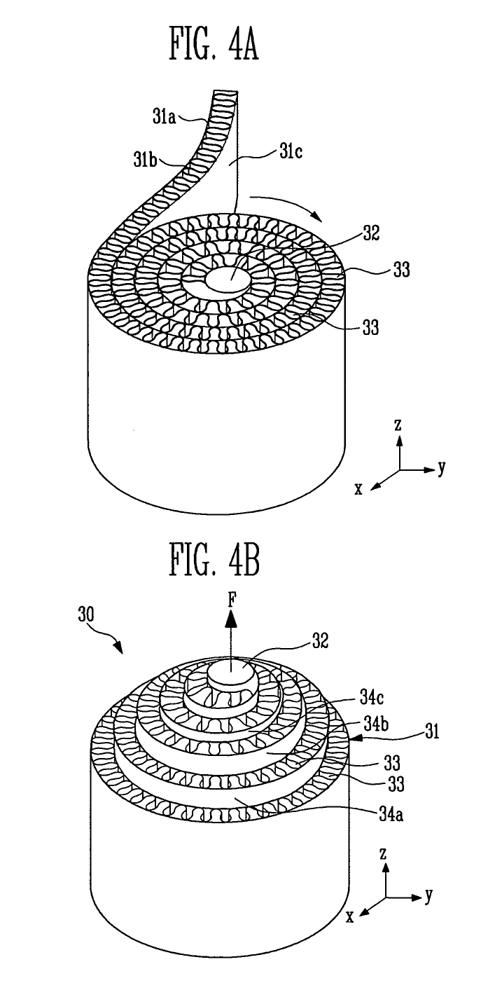

FIGS. 3A and 3B illustrate perspective views explaining a method of manufacturing the catalyst support of FIG. 1.

Referring to FIG. 3A, according to an embodiment, a base member 11R may be prepared to have a cylindrical shape. The base member 11R may be, e.g., a metal or ceramic monolith. The base member 11R may have a flat first surface 11Ra and second surface 11Rb, one at each end in a longitudinal direction. The second surface 11Rb may be flat or another shape.

Referring to FIG. 3B, a plurality of holes 13a may be formed in the base member 11R. In an implementation, the holes 13a may be formed using an appropriate tool, e.g., a laser device or a mechanical processing device such as a drill, etc. A separate process may be used to form the plurality of holes 13a, or the plurality of holes 13a may be formed simultaneously with the base member 11R, rather than through a separate process. Thus, in another implementation, the holes 13a may be formed at the same time the base member 11R is formed, e.g., using a casting operation, etc. In cross-section, the holes 13a may form a honeycomb shape.

Referring to dashed line 11Rc in FIG. 3B, the first surface 11Ra of the base member 11R may be processed, e.g., by being ground or cut away, to up to the dashed line 11Rc so as to shape the base member 11R. In an implementation, the central portion on the first surface 11Ra may be formed to have a convex shape in which the central portion projects relative to the periphery. Thus, a support having the configuration of catalyst support 10 in FIG. 1 may be obtained. The second surface 11Rb may be flat, may be processed to have a same shape as the first surface 11Ra, or may be processed to have a different shape.

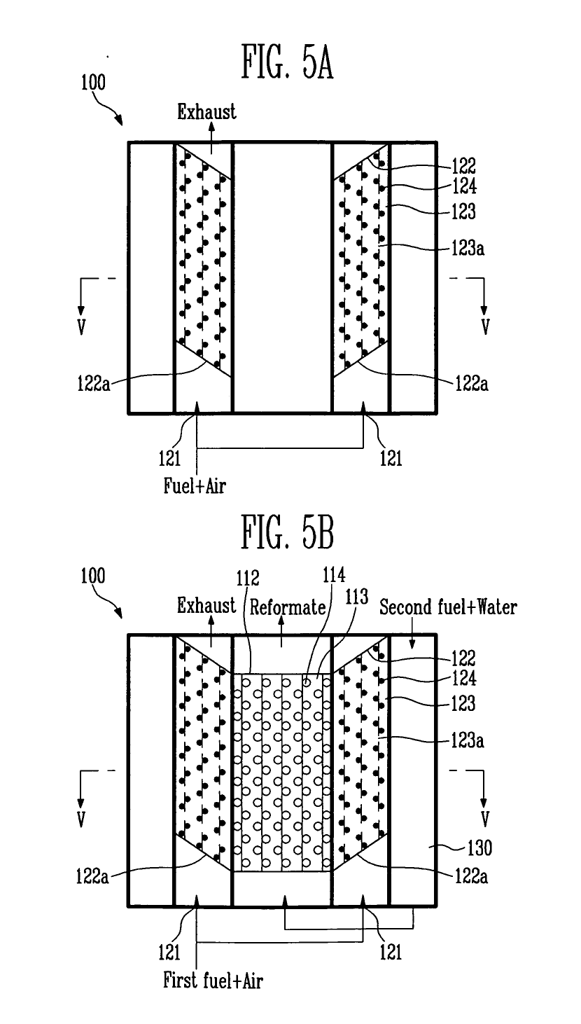

FIGS. 4A and 4B illustrate perspective views explaining a method of manufacturing a catalyst support according to a second embodiment.

Referring to FIG. 4A, the catalyst support according to the second embodiment may be formed by joining a first base member 31a and a second base member 31b together. In an implementation, the first base member 31a and/or the second base member 31b may be creased or folded to have a wave-like (serpentine) form, e.g., as shown for the second base member 31b in FIG. 4A. The wave-like form may thus form a plurality of adjacent but distinct flow paths that extend in the Z direction through the catalyst support.

The first base member 31a and the second base member 31b may be rolled together so they overlap, thus forming a spiral when viewed from one end. A central portion 32 may be left open, or may be substantially occupied by the wound first and second base members 31a, 31b.

The first base member 31a and/or the second base member 31b may include, e.g., a thermally conductive or metallic material. If the thermally conductive or metallic material is used, heat produced by the catalyst reaction may be efficiently transferred to the outside, and/or heat required in a catalyst-promoted reaction in the catalyst support may be easily obtained from an external heat source. In another implementation, the first base member 31a and/or the second base member 31b may include, or may be formed from, an insulating material.

In an implementation, a third base member 31c, e.g., formed as another sheet, may also be included. For example, the third base member 31c may be installed to interpose between the second base member 31b and the facing surface of the first base member 31a when the base members are wound. The third base member 31c may be, e.g., thermally conductive or insulating, and various modifications can be made according to the specific requirements of the structure.

Referring to FIG. 4B, the central portion 32 or central axis of the spiral structure may be pulled in the inlet direction ‘F’ so that the central axis is extended in the Z direction by a predetermined length, relative to the periphery. In FIG. 4B, the arrow for direction ‘F’ points opposite to the fluid flow in the case that first end portions 33 are first to receive the fluid. In another implementation, hot spots may be avoided by using the concave surface at the bottom of the spiral as an inlet, such that outermost regions of the support are heated at the bottom-most portion of the support, and inner-most regions of the support are heated at a location that is longitudinally inset from the bottom-most portion by a predetermined amount.

The spiral structure may have a spiral tower shape in perspective view, or, in an X-Z or Y-Z cross-section, a stair shape that it is heightened by a series of stairs each having a predetermined height from the edge thereof. As shown in FIG. 4B, first end portions 33 of the plurality of paths formed by the first and second base members 31a, 31b, may form a plurality of step portions. The first end portions 33 may step sequentially upward in the Z direction, i.e., in the ‘F’ arrow direction, with each step projecting relative to an outwardly-adjacent step, thus forming a stair case in cross-section from the edge of the side surface to the central portion of the catalyst support.

In further detail, a first step portion 34a may be formed between a first step and a second step, and the second step may be projected in the Z direction at a predetermined height, relative to the first step, corresponding to the first step portion 34a. Similarly, a second step portion 34b may be formed between the second step and a third step, and the third step may be projected in the Z direction at a predetermined height, relative to the second step, corresponding to the second step portion 34b. Further, a third step portion 34c may be formed between the third step and a fourth step, and the fourth step may be projected in the Z direction at a predetermined height, relative to the third step, corresponding to the third step portion 34c.

In an implementation, the first base member 31a may be fixed to the second base member 31b. The first and second base members 31a, 31b may be fixed together using, e.g., a brazing method in the case that the first and second base members 31a, 31b are each metallic. When the metallic third base member 31c is used, the third base member 31c may also be coupled to the second base member 31b using the brazing method.

A catalyst may be coated in the plurality of paths 33 between the first base member 31a and the second base member 31b. The catalyst may be separately applied before or after the first and second base members 31a, 31b are joined, or may be integral with the first and/or second base members 31a, 31b. The catalyst may be selected according to a target reaction. For example, in the case of a thermal oxidation reaction, at least one of PdAl₂O₃, NiO, CuO, CeO₂, Al₂O₃, Rh, Pd, and Pt may be used as the catalyst. In an implementation, the catalyst may have a pellet shape, etc., and may be filled in the flow paths defined by the first and second base members 31a, 31b.

The density of the plurality of paths 33 between the first base member 31a and the second base member 31b, that is, the cell density of the catalyst support, is preferably about 200 cells per inch-square (cpi) to about 1,500 cpi.

As described above, first end portions 33 positioned adjacent to the central portion 32 may project, relative to a plane oriented perpendicular to the Z direction, to form a convex or circular arc shape in cross-section, or a spiral tower shape in perspective view. In another implementation, the first end portions 33 positioned in the central portion 32 may be pressed downward relative to the periphery, i.e., pressed in a −Z direction, so that they may have a concave circular arc shape or an inwardly-formed spiral tower shape, i.e., so as to be plane-symmetric to the shape shown in FIG. 4B.

Also, the first end portions 33 of the plurality of paths may each have a step shape, or may be tilted at an angle, i.e., to form a cone, etc. In another implementation, a wedge may be formed, e.g., by grinding or sawing the form shown in FIG. 3A along a plane angled relative to the X-Y plane. For example, a solid parallelogram shape may be formed.

Also, the first end portions 33 may have a ripple shape, an ‘M’ or ‘W’ shape, or an uneven shape so as to change height in the Z direction. For example, the first end portions 33 positioned in the central portion may first be pulled in the Z direction by a first length and then pushed in the −Z direction by the first length, so as to form an ‘M’ shape in which a middle part, midway between the center and the periphery, is further projected than both the center and the periphery. Such a configuration may spread heat over a greater longitudinal area so as to minimize hot spots, while reducing an overall length of the catalyst support. Such a configuration may be shorter than a cone or spiral tower, and may be particularly useful when the overall diameter of the catalyst support is relatively large.

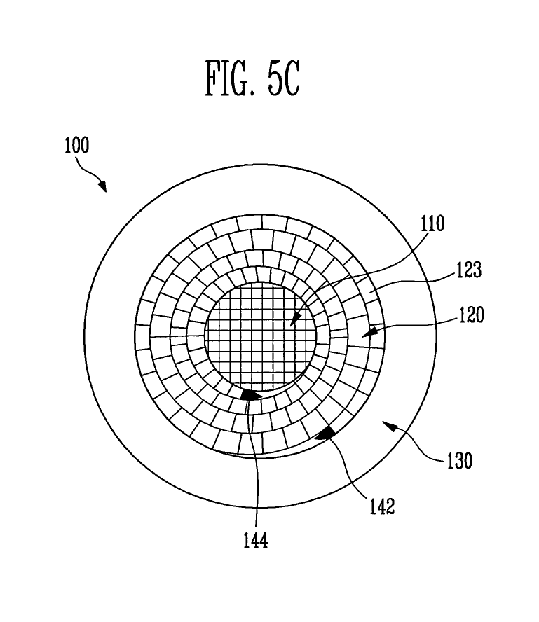

FIG. 5A-5C illustrate cross-sectional views of a reformer according to a third embodiment. FIG. 5A shows a partial view of the reformer including a catalyst support according to an embodiment. FIG. 5B illustrates the reformer of FIG. 5A with additional aspects shown. FIG. 5C illustrates a cross-sectional view of the reformer taken along line V-V of FIG. 5B. In FIG. 5C, catalyst materials are not shown for the convenience of explanation.

Referring to FIGS. 5A-5C, the reformer 100 according to the third embodiment may include a reforming reaction part 110, an oxidation reaction part 120, and a preheating part 130. The reforming reaction part 110 may contain the reaction whereby a hydrocarbon is reformed to produce hydrogen gas. The oxidation reaction part 120 may contain an oxidative and exothermic reaction of a first fuel, and may heat the reforming part 120 and/or the preheating part 130. The preheating part may channel the hydrocarbon while heating the same to a predetermined temperature.

In further detail, the reforming reaction part 110 may include a support 112 having a plurality of paths 113. Catalyst materials 114 may be coated in the respective paths 113. The reforming part 110 may reform the hydrocarbon, e.g., methane, propane, natural gas, an alcohol, etc. to generate a reformate. The reformate may contain a large quantity of hydrogen gas, and may further contain carbon monoxide and/or carbon dioxide. A steam reforming reaction whereby the hydrocarbon is converted to hydrogen gas can be represented by the following Reaction Formula 1.

—CH₂—+H₂O→CO+2H₂ [Reaction Formula I]

As example catalyst materials 14 for the steam reforming reaction, Ni/Al₂O₃, Ru/ZrO₂, Ru/Al₂O₃, and/or Ru/CeO₂—Al₂O₃ may be used.

When the reformer 100 includes a water gas shift reaction part or a selective oxidation reaction part on a downstream side of the reforming reaction part 110, the reformer 100 may use one or more of Cu, Zn, Fe, Cr, Cr₂O₃/Fe₃O₄, Pt/CeO₂, and Cu/ZnO/Al₂O₃ as catalyst materials for the water gas shift reaction, or may use one or more of Ru, Rh, Pt/Al₂O₃, TiO₂, ZrO₂, and Au/Fe₂O₃ as catalyst materials for the selective oxidation reaction.

The oxidation reaction part 120 may supply heat generated by the catalyst oxidation reaction to the reforming reaction part 110. The oxidation reaction part 120 may include a base member 122 having a plurality of paths 123. Catalyst materials 124 may be coated in the respective paths 123.

The base member 122 may be formed as described above in connection with FIGS. 1-4B. In an implementation, the base member 122 may be formed as described above in connection with FIGS. 4A and 4B, and may include a first base member on a sheet and a creased second base member. The base member 122 may be formed to spirally surround the reforming reaction part 110, centering on the reforming reaction part 110. The catalyst materials 124 may include metal catalysts for a thermal oxidation reaction.

In an implementation, the oxidation reaction part 120 may further include sub-paths 123a that intermittently connect adjacent paths from among the plurality of paths 123. The sub-paths 123a may allow fluids passing through the plurality of paths 123 to move freely between adjacent paths, so that the amount of contact between the fluids and the catalysts is increased, making it possible to enhance reaction efficiency.

As shown in FIG. 5C, the oxidation reaction part 120 may further include a pair of connection terminals 142 and 144 that are coupled to heating elements for preheating. The pair of connection terminals 142 and 144 may be installed at one end of the central portion-side and the other end of the edge-side, respectively, and may be connected to an external power supplier. In an implementation, the first base member, the second base member, and/or the third base member may be electrically insulating, while another of the first base member, the second base member, and the third base member may have a predetermined electrical conductivity, such that a spiral electrically conductive path is formed that has a predetermined resistance. With the pair of connection terminals 142 and 144 connected to the external power supplier, the spiral oxidation reaction part 120 may thus function as a thermal load, making it possible to appropriately preheat the oxidation reaction part 120 itself or the entirety of the reformer 100. Such a configuration may be appropriately used when the reformer 100 is first started, e.g., when the reformer 100 starts at a temperature lower than a room temperature (for example, 20° C. or below).

The oxidation reaction part 120 may be substantially the same as the catalyst support of FIG. 4B, while additionally providing space for the reforming reaction part 110 positioned in the middle part of the oxidation reaction part 120, and providing for the pair of connection terminals 142 and 144, and the sub-paths 123a.

In the oxidation reaction part 120, one surface 122a of the catalyst support may be tilted towards an inlet port 121 of a first fuel, which may be consumed in an oxidative reaction to produce heat. The first fuel may be the same or different from the hydrocarbon (hereinafter, the hydrocarbon will be referred to as the second fuel, for clarity). The respective first end portions of the plurality of paths 123 positioned on the first surface 122a, i.e., the leading or inlet surface, may be disposed so that the in-flowing first fuel most actively performs the thermal oxidation reaction at different positions, i.e., a positions disposed or offset in the Z direction sequentially from a path adjacent to the reforming reaction part 110 to a path farthest from the reforming reaction part 110. Thus, the oxidation reaction part 120 may disperse the heat-generating regions where the thermal oxidation reaction of the first fuel is most actively performed in order to prevent large hot spots from being formed in a predetermined region of the oxidation reaction part 120.

The preheating part 130 may serve to preheat a reactant fluid that is supplied to the reforming reaction part. The preheating part 130 may include a path through which the second fuel and water pass, the second fuel and water being heated by the heat generated from the oxidation reaction part 120. The preheating part may be coupled to the reforming reaction part 110 such that all of the preheated reactant fluid exiting the preheating part is supplied to the reforming reaction part 110. The preheating part 130 may be connected to the reforming reaction part 110 through a separate pipe.

The reforming reaction part 110 may have a first chamber having at least one inlet port, into which the second fuel and water flow from the preheating part 130, and an outlet port from which a hydrogen gas-containing reformate is discharged. The oxidation reaction part 120 may have a second chamber having at least one inlet port 121, into which the first fuel and/or air flows, and an outlet port for an exhaust of combustion by-products.

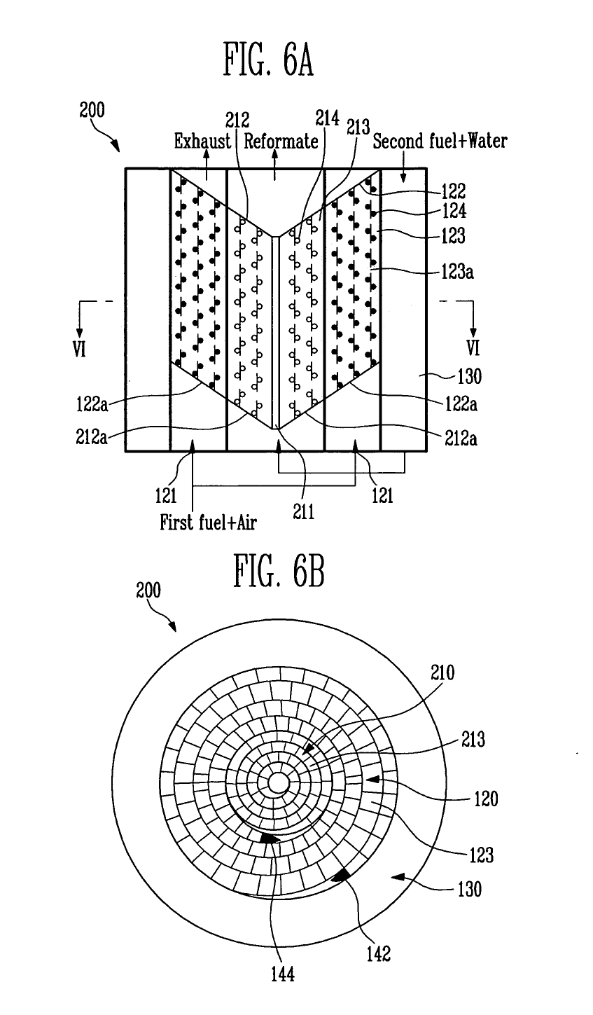

FIGS. 6A-6B illustrate cross-sectional views of a reformer 200 according to a fourth embodiment. FIG. 6A is a schematic view of the reformer 200 with a catalyst support. FIG. 6B is a cross-sectional view of a reformer taken along line VI-VI of FIG. 6A.

Referring to FIGS. 6A and 6B, the reformer 200 may include a reforming reaction part 210, an oxidation reaction part 120, and a preheating part 130.

The reforming reaction part 210 may steam-reform the second fuel, which may receive heat from the oxidation reaction part 120, and which may be supplied through the preheating part 130. The second fuel may include, e.g., natural gas having methane as a main component. The steam reforming reaction of methane may be performed at a temperature of, e.g., about 800° C.

The reforming reaction part 210 may include a base member having a plurality of paths 213 spirally surrounded and extended in a direction approximately parallel with a spiral axis direction. Reforming catalyst materials 214 may be coated on an inner surface of each path 213. A first surface 212a of the base member 212, that is, a surface at which first end portions of the plurality of paths 213 are positioned, may be tilted from a central portion 211 in a spiral structure to an edge, as shown in FIG. 6A.

The respective first end portions of the plurality of paths 213 positioned on the first surface 212a may be disposed so that the in-flowing second fuel most actively performs the thermal oxidation reaction at different positions sequentially disposed from a path adjacent to the central portion 211 of the reforming reaction part 210 to a path adjacent to the oxidation reaction part 120. Thus, the oxidation reaction part 210 may disperse the heated region where the thermal oxidation reaction of the second fuel is most actively performed to prevent large hot spots from being formed in a predetermined region of the oxidation reaction part 210.

In an implementation, the reforming reaction part 210 may substantially corresponds to the catalyst support of FIG. 4B, further providing for the features that the target reaction is the reforming reaction rather than the thermal oxidation reaction. In another implementation (not shown), the reforming part may be formed as described in connection with FIGS. 1-3B.

As shown in FIG. 6B, and similar to the description provided above in connection with FIG. 4B, the oxidation reaction part 120 may be formed to spirally surround the reforming reaction part 210, centering on the reforming reaction part 210. Thus, a double spiral structure may be formed by overlappedly rolling a sheet-shaped base member and a creased base member on an external surface of the reforming reaction part 210, which itself is spirally rolled and has a central portion projected in one direction. The first end 122a may be formed in a tilted shape by pulling edge parts in one direction. The oxidation reaction part 120 may be substantially the same as the oxidation reaction part of the reformer explained with reference to FIG. 5B.

The reformer 200 may be substantially the same as the reformer 100, except for the differences in the reforming reaction part 210.

The reforming reaction part 210 may have a first chamber including at least one inlet port, into which the second fuel and water flow from the preheating part 130, and an outlet port from which the hydrogen gas-containing reformate is discharged. Also, the oxidation reaction part 120 may have a second chamber including at least one inlet port 121 into which the first fuel and/or air flows, and an outlet port for an exhaust.

As described above, embodiments may prevent hot spots from being generated on the catalyst support. Therefore, the term of durability of a metal catalyst and support can be extended. Furthermore, a highly efficient and highly durable catalyst reactor may be easily and simply manufactured using the catalyst support. Further, the catalyst support may be easily manufactured in a mass production line, such that product yield may be enhanced and the manufacturing cost thereof may be reduced.

Some reforming reactions may be endothermic, such that heat must be supplied to the reformer in order to drive the reaction. Thus, as described herein, an oxidative reaction may be employed to supply such heat. In an implementation, the reformer in the aforementioned embodiments may further include an ignition unit for igniting the first fuel supplied to the oxidation reaction part using the catalyst oxidation method. The configuration and operation of the ignition unit used in the reformer may be of a generally-known design and thus the detailed description thereof will be omitted.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A catalyst support, comprising:
a base member; and
a plurality of paths extending through the base member in a first direction from a first end of the base member to a second end of the base member, wherein:
each path has a first end at the first end of the base member and a second end at the second end of the base member, and
the first ends of the paths are disposed at different intervals from a plane that is perpendicular to the first direction.

2. The catalyst support as claimed in claim 1, wherein the first end of the base member is an inlet and the second end of the base member is an outlet.

3. The catalyst support as claimed in claim 2, wherein:
a first set of paths has first ends disposed at a first interval from the plane,
a second set of paths has first ends disposed at a second interval from the plane, and
the second interval is different from the first interval, such that the first ends of the second set of paths are offset relative to the first ends of the first set of paths.

4. The catalyst support as claimed in claim 3, wherein:
the base member has an outer periphery and a center, and
the second set of paths are disposed closer to the outer periphery than the first set of paths.

5. The catalyst support as claimed in claim 1, wherein the catalyst support is symmetric when rotated about a central axis, the central axis being parallel to the first direction.

6. The catalyst support as claimed in claim 1, wherein the catalyst support is asymmetric when rotated about a central axis, the central axis being parallel to the first direction.

7. The catalyst support as claimed in claim 6, wherein the first ends of the paths are tilted from a peripheral edge of the base member to an opposite peripheral edge of the base member based on a cross-section of the base member that is parallel to the plane.

8. The catalyst support as claimed in claim 1, wherein the first end portions of the paths are arranged to form a ripple shape that extends in a direction parallel with an extending direction of the plane.

9. The catalyst support as claimed in claim 1, wherein a maximum value of the intervals from the plane increases in correspondence with a cell density of the paths.

10. The catalyst support as claimed in claim 1, wherein:
the base member includes a first base member having a sheet shape and a second base member having a ripple shape and being in contact with one surface of the first base member,
the first base member and the second base member overlap and are wound in a spiral structure, and
the paths are formed between the first base member and the second base member, sidewalls of the paths being at least partially defined by the ripple shape of the second base member.

11. The catalyst support as claimed in claim 10, wherein a path at a central portion of the spiral structure formed by the first base member and second base member has the largest interval from the plane.

12. The catalyst support as claimed in claim 11, wherein:
the first end portions of the paths are arranged in a spiral tower shape, and
the first ends of the paths are arranged in a plurality of steps from a peripheral edge of the spiral structure to the central portion of the spiral structure based on a cross-section of the spiral structure that is parallel to the first direction.

13. The catalyst support as claimed in claim 10, wherein at least one of the first base member and the second base member is formed of a thermally conductive material or a metallic material.

14. The catalyst support as claimed in claim 1, wherein the base member is formed of a ceramic material having a plurality of penetration holes, the plurality of paths being defined by the plurality of penetration holes.

15. The catalyst support as claimed in claim 1, further comprising catalyst materials disposed in each of the paths.

16. A method of manufacturing a catalyst support, the method comprising:
providing a first base member having a sheet shape;
providing a second base member having a ripple shape;
forming a spiral structure by overlapping and spirally winding the first base member and the second base member; and
offsetting a central portion of the spiral structure by a predetermined interval in a direction parallel to a winding axis of the spiral structure so that a central portion of the spiral structure projects relative to a peripheral edge portion of the spiral structure or is recessed relative to the peripheral edge portion of the spiral structure.

17. The method as claimed in claim 16, further comprising fixing the first base member to the second base member.

18. The method as claimed in claim 17, wherein at least one of the first base member and the second base member is formed of a thermally conductive material or a metallic material.

19. The method as claimed in claim 17, further comprising coating a catalyst material on a plurality of paths formed between the first base member and the second base member, where sidewalls of the paths are at least partially defined by the ripple shape of the second base member.

20. A reformer, comprising:
a first chamber for a target reaction; and
a first catalyst support disposed in the first chamber, wherein the first catalyst support includes:
a base member; and
a plurality of paths extending through the base member in a first direction from a first end of the base member to a second end of the base member, wherein:
each path has a first end at the first end of the base member and a second end at the second end of the base member, and
the first ends of the paths are disposed at different intervals from a plane that is perpendicular to the first direction.

21. The reformer as claimed in claim 20, wherein the target reaction includes at least one of a catalyst-promoted reforming reaction and a catalyst-promoted oxidation reaction.

22. The reformer as claimed in claim 21, further comprising:
a second chamber surrounding the first chamber; and
a second catalyst support disposed in the second chamber.

23. The reformer as claimed in claim 22, wherein:
the first chamber has a first spiral structure, and
the second chamber has a second spiral structure, the second spiral structure encircling the first spiral structure.
